(19) United States
(12) Patent Application Publication
(10) Pub. No.: US 2020/0205604 A1
(43) Pub. Date: Jul. 2, 2020

(54) Coffee Brewing Device

(71) Applicant: Join One Electric (Shenzhen) Co., Ltd, Guang Dong (CN)

(72) Inventor: Yu-Lung Lin, Tainan City (TW)

(21) Appl. No.: 16/686,417

(22) Filed: Nov. 18, 2019

(30) Foreign Application Priority Data
Dec. 28, 2018 (TW) 107217796

(51) Int. Cl. A47J 31/44; A47J 31/08; A47J 31/46; A47J 31/52; A23F 5/26

(52) U.S. Cl. CPC A47J 31/4425; A47J 31/08; A23F 5/26; A47J 31/468; A47J 31/5253; A47J 31/465

(57) ABSTRACT

A coffee brewing device includes a base and a water output device. A heating device heats water in or flowing out of a water tank. A water guiding tube is connected to the water tank and an output guiding seat. A pump guides water in the water tank to the output guiding seat. The output guiding seat is mounted above the base and includes first and second water outlets aligned with different locations of a supporting portion of the base. A container is disposed on top of a rotatable disc which is disposed on the supporting portion and driven by a transmission unit. A filtering cup is detachably disposed at an opening of the container. The filtering cup includes a chamber, an opening in an upper end thereof, and an outlet in a lower end thereof. A controller controls operation of the heating device, the pump, and the transmission unit.

### BACKGROUND OF THE INVENTION

The present invention relates to a coffee brewing device and, more particularly, to a coffee brewing device capable of automatically and uniformly brewing coffee.

A conventional manual coffee brewing method includes placing a filter paper on top of a filtering cup, placing coffee powders into the filter paper, and slowly pouring hot water onto different portions of the filter cup, such that the coffee powders at different locations of the filtering cup can uniformly contact with the hot water to extract the taste of coffee. The brewing procedure takes about 3-5 minutes to extract the flavor of coffee. However, the manual brewing requires a longer period of time, and a hand of the user must continuously hold a hot water bottle to pour the water, leading to inconvenient brewing.

### BRIEF SUMMARY OF THE INVENTION

An objective of the present invention is to provide a non-high pressure coffee brewing device capable of automatically and uniformly brewing coffee.

A coffee brewing device according to the present invention includes a base having a supporting portion. A heating and water filling unit is mounted on the base and includes a water tank, a heating device, and a water output device. The heating device is configured to heat water in the water tank or water flowing out of the water tank. The water output device includes a water guiding tube, a pump, and an output guiding seat. The water guiding tube is connected to the water tank and the output guiding seat. The pump is configured to pump the water in the water tank to the output guiding seat. The output guiding seat is mounted above the base and includes a first water outlet aligned with a center of the supporting portion and a second water outlet offset from the center of the supporting portion. A rotatable disc is disposed on the supporting portion of the base and is configured to be driven by a transmission unit to rotate. A container is disposed on top of the rotatable disc and includes an opening at an upper end thereof. A filtering cup is detachably disposed at the opening of the container. The filtering cup includes a chamber in a central portion thereof, an opening in an upper end thereof, and an outlet in a lower end thereof. A controller is electrically connected to the heating device, the pump, and the transmission unit and configured to control operation of the heating device, the pump, and the transmission unit.

In an example, the base includes a chassis, a receiving portion, and an upper water outlet portion. The chassis includes a lower compartment. The supporting portion is disposed on an upper side of the chassis. The receiving portion is disposed on top of the chassis and is located on a side of the supporting portion. The upper water outlet portion is located above the supporting portion. The water tank is disposed in the receiving portion and includes an upper cover at an upper end thereof. The output guiding seat is disposed on the upper water outlet portion of the base.

In an example, the supporting portion includes a through-hole. The transmission unit includes a motor mounted in the lower compartment and having an output shaft received in the through-hole. The rotatable disc is mounted to the supporting portion of the base and includes a coupling groove coupled with the output shaft of the motor, permitting the rotatable disc to be driven by the motor.

In an example, the supporting portion of the base includes an annular groove, and the rotatable disc includes a plurality of protrusions in contact with a bottom wall of the annular groove.

The present invention will become clearer in light of the following detailed description of illustrative embodiments of this invention described in connection with the drawings.

### DESCRIPTION OF THE DRAWINGS

FIG. 1 is an exploded, perspective view of a coffee brewing device of an embodiment according to the present invention.

FIG. 2 is a perspective view of the coffee brewing device of FIG. 1.

FIG. 3 is a cross sectional view of the coffee brewing device of FIG. 2.

FIG. 4 is a cross sectional view similar to FIG. 3, illustrating operation of the coffee brewing device.

FIG. 5 is a diagrammatic top view of the coffee brewing device of FIG. 2, illustrating operation of the coffee brewing device.

### DETAILED DESCRIPTION OF THE INVENTION

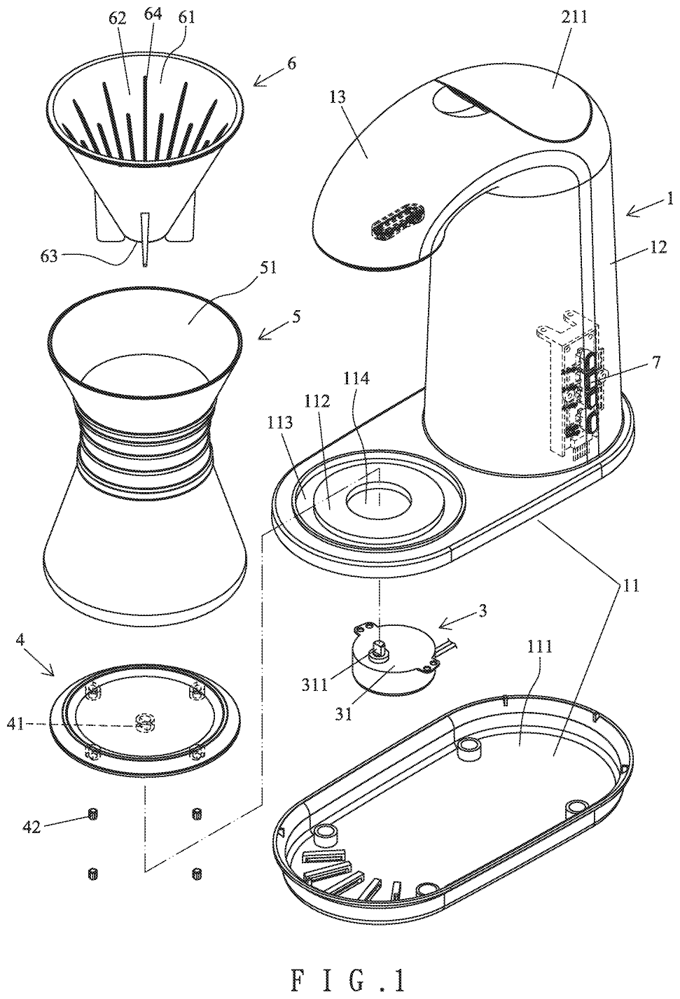

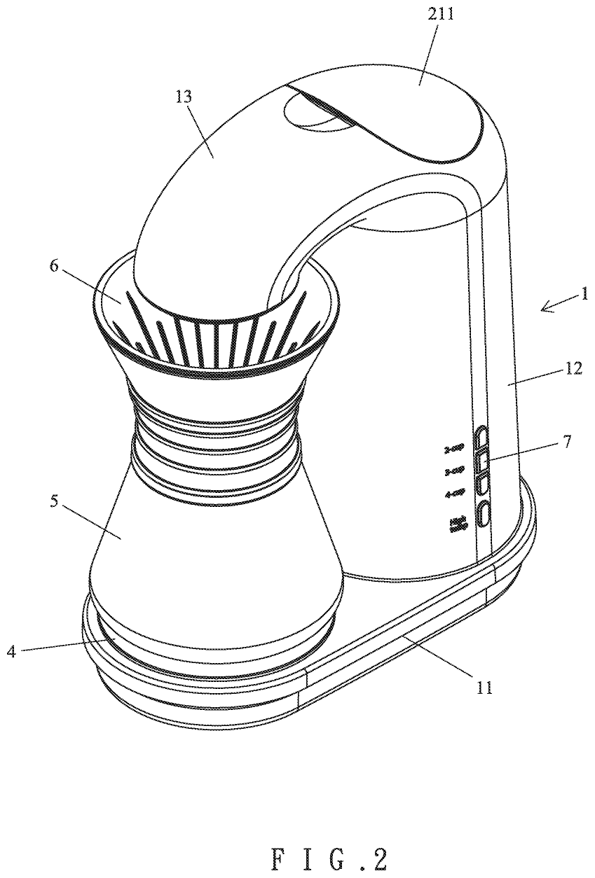

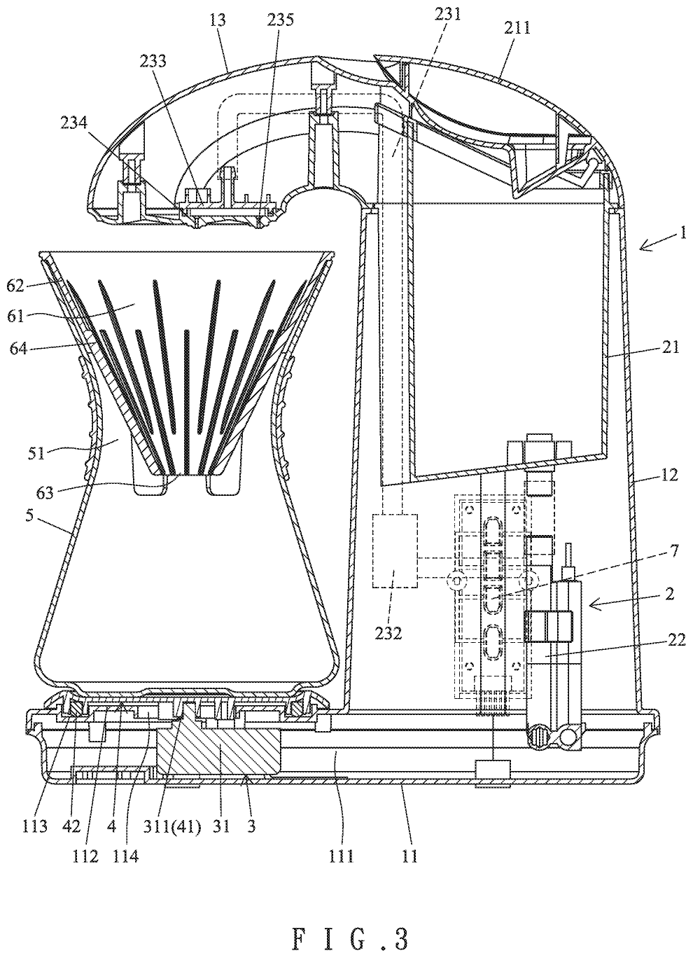

With reference to FIGS. 1-5, a coffee brewing device of an embodiment according to the present invention includes a base 1, a heating and water filling unit 2, a transmission unit 3, a rotatable disc 4, a container 5, a filtering cup 6, and a controller 7. The base 1 includes a chassis 11, a receiving portion 12, and an upper water outlet portion 13. The chassis 11 includes a lower compartment 111 and a supporting portion 112 disposed on an upper side of the chassis 11. The supporting portion 112 includes an annular groove 113 and a through-hole 114 in a center of the annular groove 113. The receiving portion 12 is disposed on top of the chassis 11 and is located on a side of the supporting portion 112. The upper water outlet portion 13 is located above the supporting portion 112.

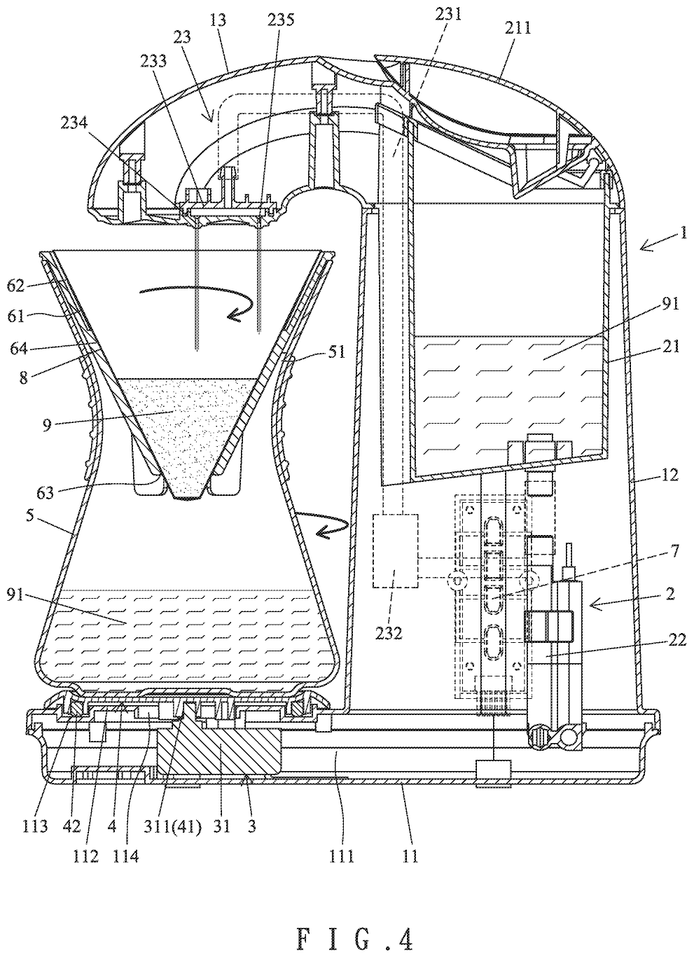

The heating and water filling unit 2 is mounted on the base 1 and includes a water tank 21, a heating device 22, and a water output device 23. The water tank 21 is disposed in the receiving portion 12 of the base 1 and includes an upper cover 211 at an upper end thereof. The heating device 22 is configured to heat water in the water tank 21 or water flowing out of the tank 21 (see FIG. 4). The water output device 23 includes a water guiding tube 231, a pump 232, and an output guiding seat 233. The water guiding tube 231 is connected to the water tank 21 and the output guiding seat 233. The pump 232 is configured to pump the water in the water tank 21 to the output guiding seat 233. The output guiding seat 233 is mounted above the upper water outlet portion 13 of the base 1 and includes a first water outlet 234 aligned with a center of the supporting portion 112 and a second water outlet 235 offset from the center of the supporting portion 112.

The transmission unit 3 includes a motor 31 mounted in the lower compartment 111. The motor 31 has an output shaft 311 received in the through-hole 114.

The rotatable disc 4 is disposed on the supporting portion 112 of the base 1 and is configured to be driven by the transmission unit 3 to rotate. The rotatable disc 4 includes a coupling groove 41 coupled with the output shaft 311 of the motor 31, permitting the rotatable disc 4 to be driven by the motor 31. The rotatable disc 4 includes a plurality of protrusions 42 in contact with the upper face of a bottom wall of the annular groove 113, reducing friction during rotation while improving rotational stability of the rotatable disc 4.

The container 5 is disposed on top of the rotatable disc 4 and includes an opening 51 at an upper end thereof. The filtering cup 6 is detachably disposed at the opening 51 of the container 5. The filtering cup 6 includes a chamber 61 in a central portion thereof, an opening 62 in an upper end thereof, and an outlet 63 in a lower end thereof. A plurality of ribs 64 is disposed on a surface of the chamber 61. The controller 7 is electrically connected to the heating device 22, the pump 232, and the motor 31. The controller 7 is configured to control operation of the heating device 22, the pump 232, and the motor 31.

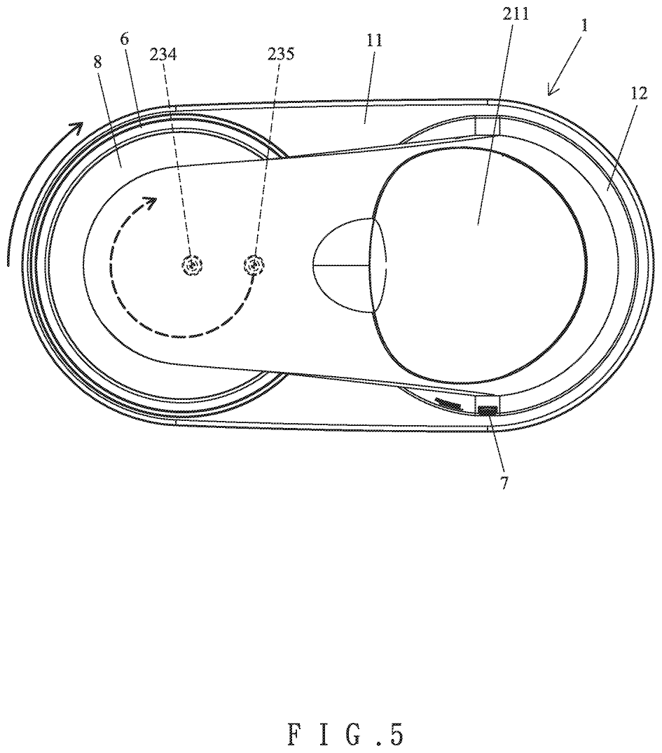

With reference to FIGS. 4 and 5, in use, water 91 is received in the water tank 21. A filter paper 8 is disposed on the filtering cup 6, and coffee powders 9 are placed in the filter paper 8. The filtering cup 6 is placed on top of the container 5, and the container 5 is placed on the rotatable disc 4. The controller 7 is operated to activate the heating device 22, the pump 232, and the motor 31. Hot water 91 is guided out of the first and second water outlets 234 and 235.

The motor 31 drives the rotatable disc 4, the container 5, and the filtering cup 6 to rotate. A portion of water 91 flowing out of the first water outlet 234 can flow through the central portion of the filtering cup 6. Another portion of water 91 flowing out of the second water outlet 235 can flow through the peripheral portion of the filtering cup 6. Thus, the hot water 91 can uniformly brew coffee powders 9 and can be then guided through the filter paper 8 and the outlet 63 of the filtering cup 6 to the container 5.

The controller 7 can be operated to control the pump 232 to thereby adjust the flow rate at the first and second water outlets 234 and 235 and to thereby adjust the rotational speed of the motor 31 and the filtering cup 6, thereby obtaining differing brewing effects. Thus, the brewing stability can be improved, and versatile tastes can be provided. Furthermore, the brewing operation can be conducted when the container 5 on the rotatable disc 4 rotates, providing improved operational stability.

In view of the foregoing, the coffee brewing device according to the present invention automatically brews coffee, provides operational stability, and provides different tastes.

Although specific embodiments have been illustrated and described, numerous modifications and variations are still possible without departing from the scope of the invention. The scope of the invention is limited by the accompanying claims.

1. A coffee brewing device comprising:
a base including a supporting portion;
a heating and water filling unit mounted on the base and including a water tank, a heating device, and a water output device, wherein the heating device is configured to heat water in the water tank or water flowing out of the water tank, wherein the water output device includes a water guiding tube, a pump, and an output guiding seat, wherein the water guiding tube is connected to the water tank and the output guiding seat, wherein the pump is configured to pump the water in the water tank to the output guiding seat, and wherein the output guiding seat is mounted above the base and includes a first water outlet aligned with a center of the supporting portion and a second water outlet offset from the center of the supporting portion;
a transmission unit;
a rotatable disc disposed on the supporting portion of the base and configured to be driven by the transmission unit to rotate;
a container disposed on top of the rotatable disc and including an opening at an upper end thereof;
a filtering cup detachably disposed at the opening of the container, wherein the filtering cup includes a chamber in a central portion thereof, an opening in an upper end thereof, and an outlet in a lower end thereof; and
a controller electrically connected to the heating device, the pump, and the transmission unit and configured to control operation of the heating device, the pump, and the transmission unit.

2. The coffee brewing device as claimed in claim 1, wherein the base includes a chassis, a receiving portion, and an upper water outlet portion, wherein the chassis includes a lower compartment, wherein the supporting portion is disposed on an upper side of the chassis, wherein the receiving portion is disposed on top of the chassis and is located on a side of the supporting portion, wherein the upper water outlet portion is located above the supporting portion, wherein the water tank is disposed in the receiving portion and includes an upper cover at an upper end thereof, and wherein the output guiding seat is disposed on the upper water outlet portion of the base.

3. The coffee brewing device as claimed in claim 2, wherein the supporting portion includes a through-hole, wherein the transmission unit includes a motor mounted in the lower compartment and having an output shaft received in the through-hole, and wherein the rotatable disc is mounted to the supporting portion of the base and includes a coupling groove coupled with the output shaft of the motor, permitting the rotatable disc to be driven by the motor.

4. The coffee brewing device as claimed in claim 1, wherein the supporting portion of the base includes an annular groove, and wherein the rotatable disc includes a plurality of protrusions in contact with a bottom wall of the annular groove.
